(19) United States
(12) Patent Application Publication
(10) Pub. No.: US 2025/0028938 A1
(43) Pub. Date: Jan. 23, 2025

(54) NEURAL NETWORK PREDICTION MODEL FOR DYNAMIC SURVIVAL ANALYSIS USING SOFT LABELS

(71) Applicant: INTERNATIONAL BUSINESS MACHINES CORPORATION, Armonk, NY (US)

(72) Inventors: Hiroki Yanagisawa, Kawasaki (JP); Akira Koseki, Yokohama-shi (JP)

(21) Appl. No.: 18/354,591

(22) Filed: Jul. 18, 2023

(51) Int. Cl. G06N 3/047; G06N 3/0985

(52) U.S. Cl. CPC G06N 3/047; G06N 3/0985

(57) ABSTRACT

Training a prediction model for dynamic survival analysis of a training survival dataset representing a plurality of individuals includes the following operations. An estimated probability distribution for the prediction model is initialized for a batch of data from the training survival dataset. For each of a plurality of censored individuals, an individual estimated probability distribution is determined. A soft label is construed for each of the plurality of censored individuals by shifting the estimated individual probability distribution for a respective one of the plurality of censored individuals by a predetermined value. A loss is generated by summing, for each of the plurality of censored individuals, a weighted scoring rule using the soft labels and the individual probability distributions. The estimated probability function is modified based upon the loss. The determining, the generating, the constructing, and the modifying are repeated until the loss is minimized. The survival dataset includes censored data.

### BACKGROUND

The present invention relates to machine learning, and more specifically, to training a neural network prediction model for dynamic survival analysis using soft labels.

Survival analysis is a field of computer science and statistics that involves predicting a duration of time until a particular event occurs. As the name implies, ‘survival analysis’ initially began as a technique used to determine the predicted expiration of a biological organism based upon characteristics of this organism. However, survival analysis is not limited in this manner. For example, survival analysis can be used to predict a failure in a mechanical system (e.g., a hard drive fails) as part of engineering reliability analysis. As another example, survival analysis can be used by an internet provider to predict when a customer may terminate a contract.

Aspects of survival analysis can be described with regard to FIG. 1A. A dataset D={(x1, z1, d1), (x2, z2, d2), . . . , (xn, zn, dn)} is provided as an input where: xi represents a feature vector for a patient (or object), zi represents the time of event (ti) or the censored time (ci), and the binary indicator (di) represents whether zi is uncensored (di=1) or censored (di=0). A censored data point (i.e., a data point with di=0) means that the exact time of the event (ti) is unknown, and the only thing that is known is that ti>ci. While the present disclosure uses the term “patient.” the term “patient” is used as a placeholder for any object capable of being subject to survival analysis.

The censored time (ci) represents the time after which observation has ended (e.g., after the end of the study). By way of example, if the dataset included hard drives that were observed over a 5 year period, and one of the hard drives failed/expired 3 months after the observation had concluded (i.e., after the censored time), then this data point would be censored (i.e., di=0). Another phrase used to describe such an event is that the event was “right-censored.” Other types of right-censored events occur when the patient withdraws from the study or is lost to follow-up. A “left-censored” event is one in which failure/expiration occurs prior to the start of the study. In this instance, the “birth event” occurs prior to the start of the study, and consequently, a timer may not be started. Accordingly, these types of events are usually excluded from the dataset. What constitutes a “birth event” can vary depending upon what is being studied. For example, in a medical context, a birth event may be when a patient enters the hospital. In an engineering context, a birth event may be when a product is installed or otherwise placed into operation.

Referring to FIG. 1B, a prediction model 110, used as part of machine learning including, for example, neural networks, is used to estimate a probability distribution \hat{q}ₓ of a particular event occurring (or not) over time t.

Survival analysis can be classified into a static version and a dynamic version. In static survival analysis, each data point contains a single state and its observation time (i.e., the event time or the censoring time). In dynamic survival analysis, states and observation times are given as a sequence of observations. The observations are oftentimes irregularly-sampled in practice, which leads to varying intervals between consecutive observations. FIG. 2 illustrates an example of how a feature vector of a patient changes over time during dynamic survival analysis.

The trajectory of a patient is modeled by a discrete-time Markov process over a set of states X and a set of discrete times T={0, 1, 2, . . . , |T|−1}. The process is assumed to be time-homogenous, which means that the transition probability p_{xx′} depends only on x and x′ and not on time. The Markov process contains a special state Ø_{T}∈X, which corresponds to a terminal state (e.g., a patient is deceased or a device has failed). When the process reaches this state, the process immediately stops as the event of interest has occurred. Additionally, the Markov process has a stopping time c∈T, where c is a sample from random variable C. The stopping time corresponds to censoring, and a special state Øc∈X is used to represent that this Markov process stops at time c˜C.

Dynamic survival analysis is the problem to estimate the time tₓ to reach the terminal Ø_{T}∈X from a given state x∈X. The time tₓ is referred to as event time in survival analysis. The event time tₓ is assumed to be a sample obtained from an underlying random variable Tₓ (i.e., tₓ˜Tₓ), and the goal of dynamic survival analysis is to estimate the probability distribution Tₓ for each x∈X. In survival analysis, the probability distribution Tₓ is represented as: f(t|x)=Pr(Tₓ=t|x), and the survival function at time t is modeled as S(t|x)=Pr(Tₓ>t|x). The hazard rate is defined by h(t|x)=Pr(Tₓ=t|x, Tₓ≥t). The probability distribution of event times for state x is represented as a length-K vector qₓ.

There are two basic approaches for performing dynamic survival analysis. One approach, “Initial-S”, employs a model that solves the problem as static survival analysis using only the first and last observations of each patient. The censored negative log-likelihood is then used as the loss function. The second approach, “Landmarking”, employs a model that solves the problem using a landmarking approach. This approach is the same as the Initial-S approach except that all intermediate observations are used as input.

Referring to FIG. 3, another type of prediction model has recently been proposed for dynamic survival analysis that is sample efficient, which means that it requires a smaller number of training data points than other models to get better estimation performance. This model incorporates a technique from reinforcement learning into survival. This model is based on temporal-difference (TD) learning that exploits a temporal consistency condition in survival analysis and employs a Proportional Hazard (PH) assumption. This model is hereinafter referred to as the TD-PH model or TD-PH approach.

While the TD-PH model represents an improvement over past models, the TD-PH model still suffers from certain problems. Specifically, the TD-PH model is limited to a dataset with unit time intervals and extending this model to general time intervals is problematic. Unit time intervals are regular (e.g., every hour or every day) whereas general time intervals are irregular (e.g., only when a patient visits a hospital). Additionally, the TD-PH model employs a proportional hazard assumption, which assumes that the explanatory variable only changes the chance of failure and not the timing of periods of high hazard. Consequently, the true probability distribution function q(x, t) must be represented as a product of time-dependent term g(t) and x-dependent term h(x), as in q(x, t)=g(t)h(x), where h(x) is the hazard rate. Thus, the explanatory variable acts directly on the baseline hazard rate and not on the failure time. However, the proportional hazard assumption does not hold in general, and consequently, a more sophistical model is needed for dynamic survival analysis.

### SUMMARY

A computer-implemented process for training a prediction model for dynamic survival analysis of a training survival dataset representing a plurality of individuals includes the following operations. An estimated probability distribution for the prediction model is initialized for a batch of data from the training survival dataset. For each of a plurality of censored individuals, an individual estimated probability distribution is determined. A soft label is construed for each of the plurality of censored individuals by shifting the estimated individual probability distribution for a respective one of the plurality of censored individuals by a predetermined value. A loss is generated by summing, for each of the plurality of censored individuals, a weighted scoring rule using the soft labels and the individual probability distributions. The estimated probability function is modified based upon the loss. The determining, the generating, the constructing, and the modifying are repeated until the loss is minimized. The survival dataset includes censored data.

In other aspects of the process, the soft labels can be constructed using an estimation of a probability of event occurrence and an estimation of a probability of survival function, and the soft labels can also be constructed as a probability distribution in a form of a length-K vector. The scoring rule can be a Bregman divergence, and the scoring rule can be weighted by an estimated probability distribution of censoring time. The loss is determined to be minimized using a neural network, and the prediction model is a neural network model of the neural network. Also, the neural network model determines the individual estimated probability distributions.

A computer hardware system for training a prediction model for dynamic survival analysis of a training survival dataset representing a plurality of individuals includes a hardware processor configured to perform the following executable operations. An estimated probability distribution for the prediction model is initialized for a batch of data from the training survival dataset. For each of a plurality of censored individuals, an individual estimated probability distribution is determined. A soft label is construed for each of the plurality of censored individuals by shifting the estimated individual probability distribution for a respective one of the plurality of censored individuals by a predetermined value. A loss is generated by summing, for each of the plurality of censored individuals, a weighted scoring rule using the soft labels and the individual probability distributions. The estimated probability function is modified based upon the loss. The determining, the generating, the constructing, and the modifying are repeated until the loss is minimized. The survival dataset includes censored data.

In other aspects of the hardware system, the soft labels can be constructed using an estimation of a probability of event occurrence and an estimation of a probability of survival function, and the soft labels can also be constructed as a probability distribution in a form of a length-K vector. The scoring rule can be a Bregman divergence, and the scoring rule can be weighted by an estimated probability distribution of censoring time. The loss is determined to be minimized using a neural network, and the prediction model is a neural network model of the neural network. Also, the neural network model determines the individual estimated probability distributions.

A computer program product includes a computer readable storage medium having stored therein program code for training a prediction model for dynamic survival analysis of a training survival dataset representing a plurality of individuals. The program code, which when executed by a computer hardware system, cause the computer hardware system to perform the following. An estimated probability distribution for the prediction model is initialized for a batch of data from the training survival dataset. For each of a plurality of censored individuals, an individual estimated probability distribution is determined. A soft label is construed for each of the plurality of censored individuals by shifting the estimated individual probability distribution for a respective one of the plurality of censored individuals by a predetermined value. A loss is generated by summing, for each of the plurality of censored individuals, a weighted scoring rule using the soft labels and the individual probability distributions. The estimated probability function is modified based upon the loss. The determining, the generating, the constructing, and the modifying are repeated until the loss is minimized. The survival dataset includes censored data.

In other aspects of the computer program product, the soft labels can be constructed using an estimation of a probability of event occurrence and an estimation of a probability of survival function, and the soft labels can also be constructed as a probability distribution in a form of a length-K vector. The scoring rule can be a Bregman divergence, and the scoring rule can be weighted by an estimated probability distribution of censoring time. The loss is determined to be minimized using a neural network, and the prediction model is a neural network model of the neural network. Also, the neural network model determines the individual estimated probability distributions.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1A are 1B are respectively a graphical representation of data points in a survival analysis study and an architecture used to perform the survival analysis.

FIGS. 2 is a graphical representation of how a feature vector of a patient changes over time during dynamic survival analysis.

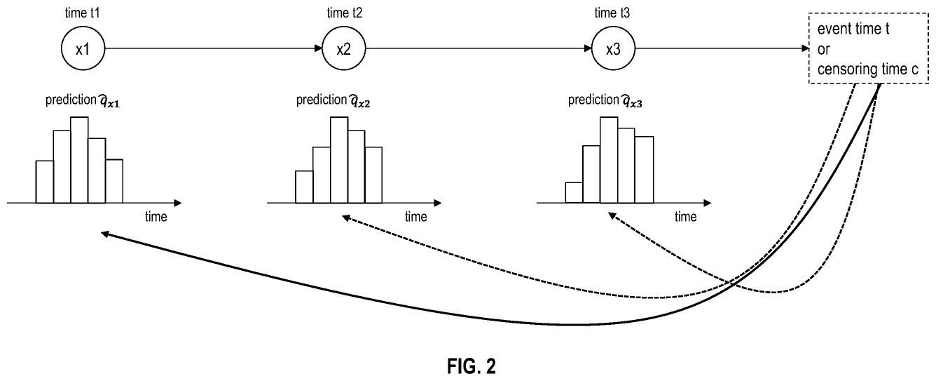

FIG. 3 graphically illustrates the TD-PH approach to dynamic survival analysis.

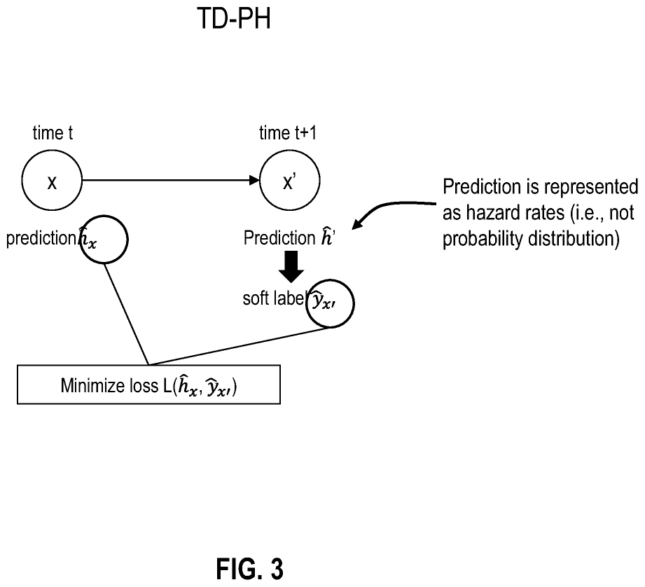

FIG. 4 is a flowchart of a typical reinforced learning (RL) approach.

FIGS. 5A and 5B are block diagrams respectively schematically illustrating a reinforced learning (RL) approach and a deep Q-learning approach (DQN).

FIG. 6 graphically illustrates the TD-CNLL approach when all data points are uncensored according to an embodiment of the present invention.

FIG. 7 illustrates the construction of soft labels according to an embodiment of the present invention.

FIG. 8 graphically illustrates the TD-CNLL approach when the data points includes censored data according to an embodiment of the present invention.

FIG. 9 is a flowchart of an example method for training a neural network prediction model for survival analysis according to an embodiment of the present invention.

FIGS. 10A-B are comparative prediction performance of TD-PH and TD-CNLL models versus ground truth using a simple Markov process.

FIGS. 11A-C are comparative prediction performance of TD-PH and TD-CNLL models for three different real training datasets modified to unit time interval.

FIGS. 12A-C are comparative prediction performance of Initial-S, Landmarking, and TD-CNLL models for three different real training datasets using original time intervals.

FIG. 13 is a block diagram illustrating an example of computer environment for implementing the methodology of FIG. 9.

### DETAILED DESCRIPTION

The present approach for solving dynamic survival analysis combines the Temporal Difference (TD) algorithm found in the TD-PH approach with Censored Negative Log-Likelihood (CNLL) found in Initial-S static survival analysis. As used herein, the approach to dynamic survival analysis disclosed is abbreviated TD-CNLL. CNLL has previously been shown to be a strictly proper scoring rule when used as part of static survival analysis. As is known, a scoring rule can also be referred to a loss function. The approach of the present disclosure modifies CNLL for discrete times since the Initial-S static survival analysis approach assumes that the event and censoring times are continuous values. CNLL is advantageous for survival analysis as it can be used for both a loss function and as an evaluation metric.

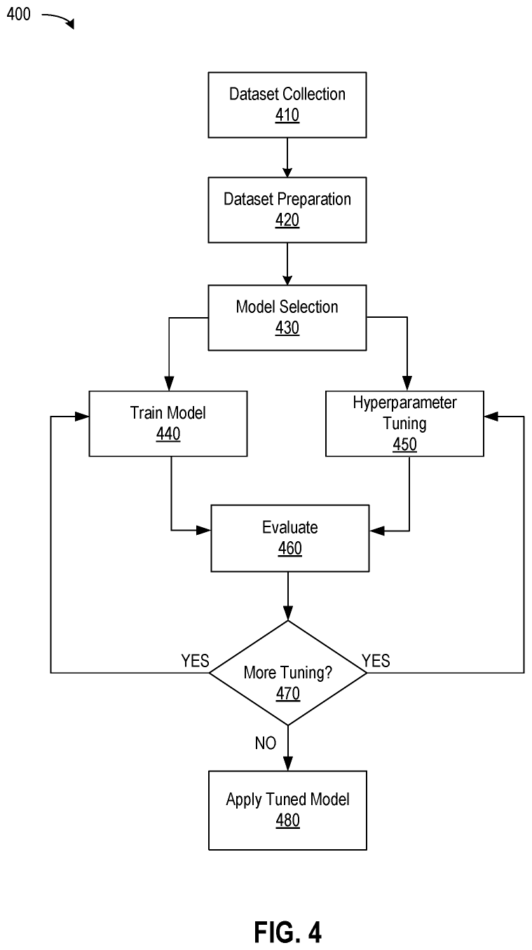

With reference to FIG. 4, a generic process 400 for machine learning is disclosed. In 410, the data used for the dataset is collected. As conventionally known, the quality of the machine learning prediction model (e.g., a neural network) being trained is dependent upon the quantity and quality of the data in the dataset. In 420, the data in the dataset is prepared, and this may involve a wide variety of different operations. For example, if the data comes from different sources, the data may require normalization and data type conversions. Also, duplicate data may be removed and errors/omissions in the data may be corrected. The data can also be randomized to reduce the impact of the particular order in which the data is collected and/or prepared.

The dataset can also be split up into multiple portions. One portion of the dataset (referred to herein as the training dataset), which is typically the largest portion, is used to train the prediction model (e.g., tune the parameters of the prediction model). Another portion of the dataset (referred to herein as the test dataset) is used to validate the final trained prediction model. Still another portion of the dataset (referred to herein as the validation dataset) is used to tune hyperparameters. In certain instances, K-fold cross-validation can be used as part of prediction model training.

In 430, the prediction model to be trained is selected. There are a number of known models that can be used with machine learning. A non-exclusive list of these models includes linear regression, Deep Neural Networks (DNN), logistic regression, and decision trees. Depending upon the type of solution needed for a particular application, one or more models may be better suited.

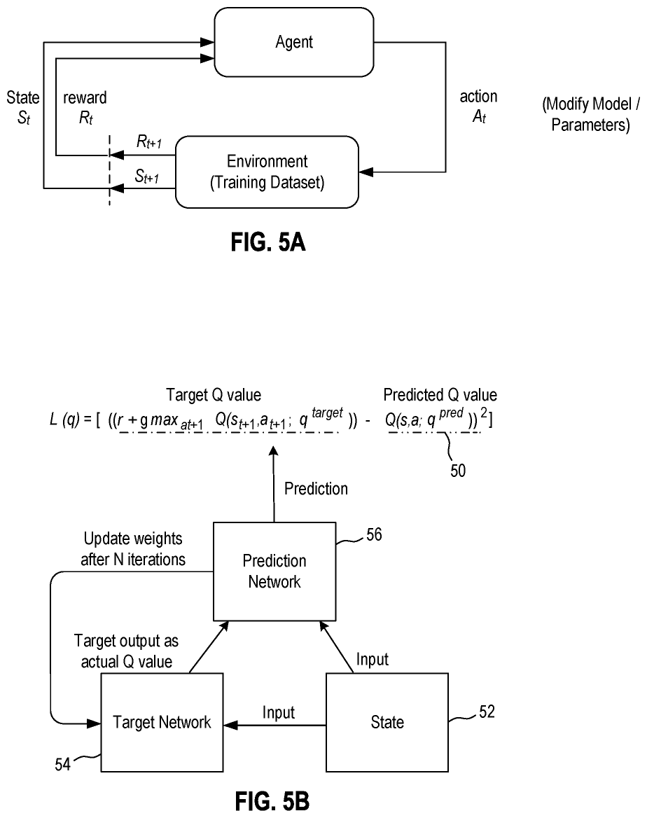

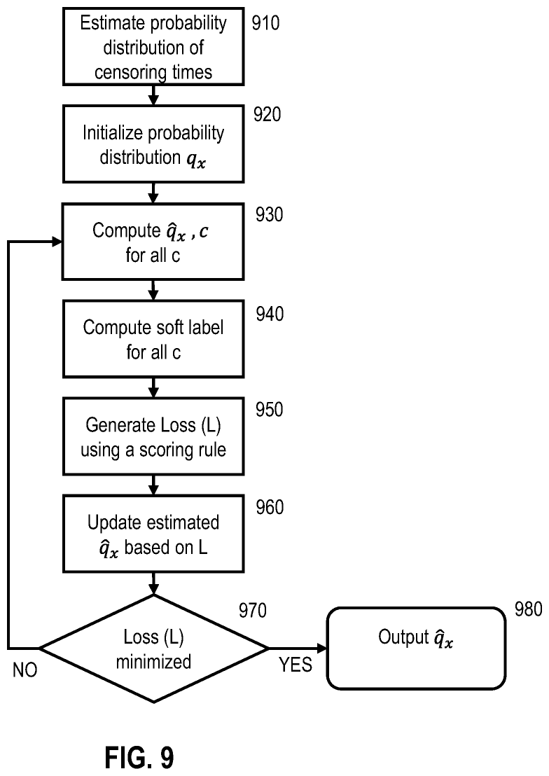

In 440, the parameters of the prediction model are tuned. There are many different types of known techniques used to train a prediction model. Some of these techniques are discussed in further detail with regard to FIGS. 5A-5B. A particular approach to training a survival prediction model is discussed in further detail with regard to FIG. 9. In 450, hyperparameters can be tuned. Hyperparameters are variables that govern the training process itself and differ from input data (i.e., the training data) and the parameters of the prediction model. Examples of hyperparameters include, for example, the number of hidden layers in a DNN between the input layer and the output layer. Other examples include number of training steps, learning rate, and initialization values. In certain instances, the validation dataset can be used as part of this tuning process. Although illustrated as being separate from the tuning of the parameters of prediction model in 450, the tuning of the hyperparameters can be performed in parallel with or in series with the tuning of the parameters of the prediction model in 440.

In 460, the parameters of the prediction model and the hyperparameters are evaluated. This typically involves using some metric or combination of metrics to generate an objective descriptor of the performance of the prediction model. The evaluation typically uses data that has yet to be seen by the prediction model (e.g., the test dataset). The operations of 440-460 continue until a determination, in 470, that no additional tuning is to be performed. In 480, the tuned prediction model can then be applied to real-world data.

FIGS. 5A and 5B are block diagrams respectively illustrating a reinforced learning (RL) approach and a deep Q-learning approach (DQN) for training a prediction model. Machine learning paradigms include supervised learning (SL), unsupervised learning (UL), and reinforced learning (RL). RL differs from SL by not requiring labeled input/output pairs and not requiring sub-optimal actions to be explicitly corrected. FIG. 5A schematically illustrates a generic RL approach. In describing RL, the following terms are oftentimes used. The “environment” refers to the world in which the agent operations. The “State” (Sₜ) refers to a current situation of the agent. Each State (Sₜ) may have one or more dimensions that describe the State. The “reward” (Rₜ) is feedback from the environment (also illustrated as “r” in FIG. 5B), which is used to evaluate actions (Aₜ) taken by the agent. In other words a reward function, which is part of the environment, generates the reward (Rₜ), and the reward function reflects the desired goal of the prediction model being trained. The “policy” is a methodology by which to map the State (Sₜ) of the agent to certain actions (Aₜ). The “value” is a future reward received by an agent by taking an action (Aₜ) in a particular State (Sₜ). Ultimately, the goal of the agent is to generate actions (Aₜ) that maximize the reward function.

Examples of RL algorithms that may be used include Markov decision process (MDP) (i.e., the methodology illustrated in FIG. 5A), Monte Carlo methods, temporal difference learning, Q-learning, Deep Q Networks (DQN), State-Action-Reward-State-Action (SARSA), a distributed cluster-based multi-agent bidding solution (DCMAB), and the like. FIG. 5B illustrates one example of the operation of a DQN prediction model. DQN is a combination of deep learning (i.e., neural network based) and reinforced learning. Deep learning is another subfield of machine learning that involves artificial neural networks. An example of a computer system that employs deep learning is IBM's Watson. While the terms “neural network” and “deep learning” are oftentimes used interchangeably, by popular convention, deep learning (e.g., with a DNN), refers to a neural network with more than three layers inclusive of the inputs and the output. A neural network with just two or three layers is considered just a basic neural network.

A neural network can be seen as a universal functional approximator that can be used to replace the Q-table used in Q-learning. In a DQN prediction model, the loss function 50 is represented as a squared error of the target Q value and prediction Q value. Error is minimized by optimizing the weights, θ. In DQN, two separate networks (i.e., target network 54 and prediction network 56 having the same architecture) can be respectively employed to estimate target and prediction Q values based upon state 52. The result from the target prediction model is treated as a ground truth for the prediction network 56. The weights for the prediction network 56 get updated every iteration and the weights of the target network 54 get updated with the prediction network 56 after N iterations.

A scoring rule S(\hat{q}ₓ, (z, δ)) for a prediction \hat{q}ₓ and a censored hard label (z, δ) is a function S: Δ_{K}x(Tx{0,1})→ [symbol] . The scoring rules are negatively-oriented. and consequently. a smaller score is better. For a strictly proper scoring rule (i.e., loss function). if an estimation \hat{q}ₓ can be found that minimizes the scoring rule S(\hat{q}ₓ, (z, δ)), then the true probability distribution can be assumed (i.e., \hat{q}ₓ=qₓ). Notably, censored negative log-likelihood S(\hat{q}ₓ, (z, δ)) is a strictly proper scoring rule and is defined as:

$$S ( {\hat{q}}_{x} , ( z , δ ) ) = - δ log {\hat{q}}_{x} [ z ] - ( 1 - δ ) log {\sum }_{i > z} {\hat{q}}_{x} [ i ] .$$

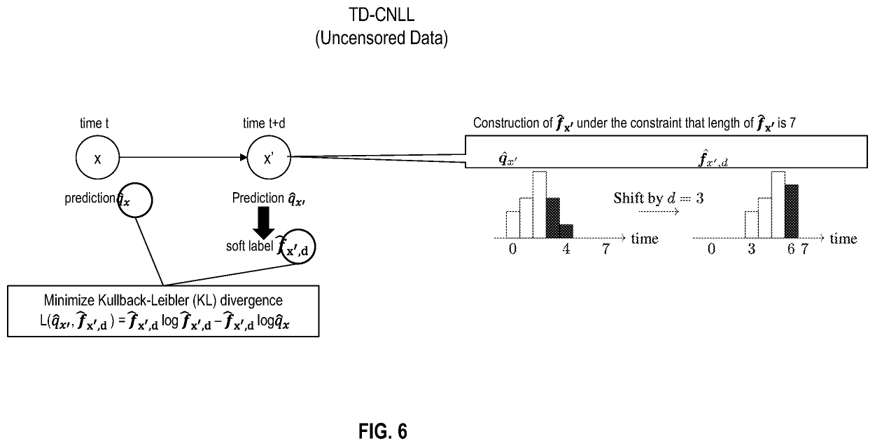

Dynamic survival analysis can be solved using any algorithm used to solve static survival analysis. As discussed above, this can include Initial-S and Landmarking. However and with reference to FIG. 6, the approach for solving dynamic survival analysis according to the present disclosure involves using soft labels. For static survival analysis, the scoring rule for the target value (z, δ) is minimized using the following equation:

$${min}_{\hat{q}} S ( {\hat{q}}_{x 1} , ( z , δ ) )$$

The approach according to the present disclosure minimizes a scoring rule for a soft label \hat{f}x′, τ′−τ assigned to an intermediate observation (x′, τ′) using the following equation:

$${min}_{\hat{q}} S ( {\hat{q}}_{x 1} , \hat{f} {x}_{2} , {τ}_{2} - {τ}_{1} )$$

While the TD-PH approach also employs soft labels, those soft labels are constructed using, respectively, estimations ĥ(t|x) and Ŝ(t|x) of the hazard rate h(t|x) and the survival function S(t|x). In contrast to the TD-PH approach, the TD-CNLL approach according to the present disclosure constructs soft labels by using estimations \hat{f}(t|x) and Ŝ(t|x) of the probability of event occurrence f(t|x) and the survival function S(t|x). In certain aspects, the soft label \hat{f}x′, d is constructed as a probability distribution in a form of length-K vector (i.e., \hat{f}_{x′,d}∈Δ_{K}). This soft label is defined to satisfy the following equation:

$${q}_{x} = \begin{matrix}𝔼 \\ ( x , τ ) \to ( {x}^{′} , {τ}^{′} )\end{matrix} [ {\hat{f}}_{{x}^{′} , d} ]$$

$$where$$

$$d = {τ}^{′} - τ$$

The soft label \hat{f}x′, d for state x′ is set to the probability distribution for state x under the assumption that the event does not happen between times τ′−τ and the state at time t′ is x′. This soft label \hat{f}x′, d for state x′≠Ø_{T} is illustrated in FIG. 6 as shifting \hat{q}ₓ₁ to the right by d. Using the equation illustrated above, the average of the soft labels assigned to the next observation should be equal to the true probability distribution qₓ such that estimated probability distribution is approximate the true probability distribution (i.e., \hat{q}ₓ≈qₓ) and the estimated soft label \hat{f}x′, d based upon \hat{q}ₓ is calibrated.

The approach according to the present disclosure illustrated in FIG. 6 is viable only if all data points are uncensored. Notably, this approach does not use the proportional hazard function, which is part of the TD-PH approach. Additionally, the approach according to the present disclosure does not assume a unit time interval such that d can be an arbitrary value.

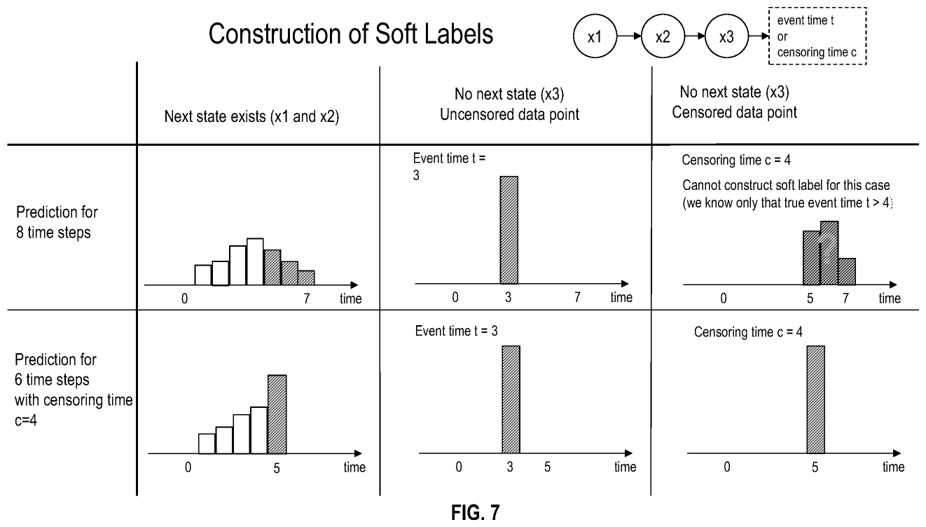

FIG. 7 illustrates the construction of soft labels depending upon whether the dataset includes censored data or not.

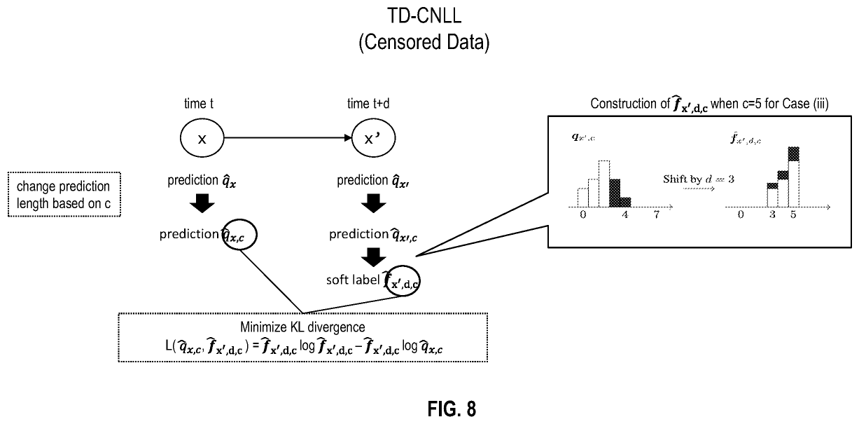

Referring to FIG. 8, the approach for solving dynamic survival analysis according to the present disclosure involves using soft labels can be extended for instances in which the data points include censored data. The soft label \hat{f}x′, d for state x′=Ø_{T} can be defined as a one-hot vector. However, the soft label for state x′=Ø_{C} cannot be defined as a one-hot vector of length K because the exact event time is not known-rather only that the event time is at least τ′ is known. Thus, the soft label for state Ø_{C} can be set such that Σ_{i>d}\hat{f}_{ØC}, d[i]=1. However, how to distribute the probability mass in the soft label is not known.

To address the problem of distributing the probability mass in the soft label and with reference to operation 910 in FIG. 9, the present approach estimates the probability π_{c}=PR(C=c) for all c∈T beforehand. Under the condition that c is known, the length-K vectors \hat{q}ₓ and \hat{f}x′, d can be truncated to length-(c+2) vectors. Under the condition that c is known, three cases can be considered during the construction of soft labels for two consecutive observation (x, τ) and (x′, τ′).

Case (i). In this case, the last observation is censored (i.e., [symbol] =Ø_{C}). A length-(c+2) vector is created as a soft label \hat{f}x′, d for state x′ as:

$${\hat{f}}_{{x}^{′} , d , c} [ i ] = \{ \begin{matrix}0 & if 0 \leq i \leq c , \\ 1 & if i = c + 1\end{matrix} .$$

Consequently, if a patient is censored (i.e., [symbol] =Ø_{C}), the soft label for any intermediate state x′ of this patient is set as a one-hot vector.

Case (ii). In this case, the next state is uncensored (i.e., x′= [symbol] =Ø_{T}). A length-(c+2) vector is created as a soft label \hat{f}Ø_{T}, d, c for state x′=Ø_{T} as:

$${f}_{{∅}_{T} , d , c} [ i ] = \{ \begin{matrix}1 & if i = d , \\ 0 & if i \neq d\end{matrix} .$$

Case (iii). In this case, the last observation is not censored and the next state is not uncensored (i.e., [symbol] ≠Ø_{C} and x′≠Ø_{T}). The probability \hat{f}(t|x′, d<t≤c) that the event is observed at time t between time d and censor time c can be represented as:

$$\hat{f} ( t \vert {x}^{′} , d < t \leq c ) = \hat{f} ( t \vert {x}^{′} ) - S ( c \vert {x}^{′} ) ,$$

under the assumption that the event and censoring times are independent. The soft label \hat{f}x′, d, c∈Δ_{c+2}, where d=τ′−τ as:

$${\hat{f}}_{{x}^{′} , d , c} [ i ] = \{ \begin{matrix}0 & if 0 \leq i \leq d , \\ \hat{f} ( i - d \vert {x}^{′} ) / \hat{S} ( c - d \vert {x}^{′} ) & if d \leq i \leq c , \\ 0 & if i = c + 1\end{matrix} .$$

Case (iii) is graphically illustrated in FIG. 8. Overall, using a Kaplan-Meier estimator to estimate the probability PR(C=c), the approach looks to:

$$min \sum PR ( C = c ) L ( {\hat{q}}_{x , c} , {\hat{f}}_{{x}^{′} , d , c} ) .$$

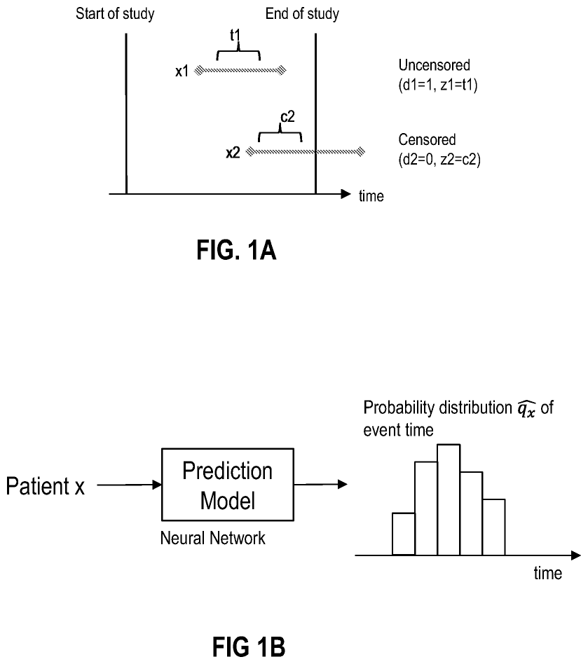

In 920, the estimated probability distribution \hat{q}ₓ is initialized as \hat{q}ₓ∈Δ_{K}. Although not limited in this manner, \hat{q}ₓ can be using a random number when operated as part of a neural network model. Once the parameters of the neural network model have been set, the neural network model can be used to obtain an initial prediction. For example, if a state x is fed as an input to the neural network model, the neural network model outputs a predicted \hat{q}ₓ as illustrated in FIG. 1B.

In 930, the estimated probability distribution \hat{q}_{x,c} is determined for all c, which is then used to construct a soft label \hat{f}_{x′,d,c} in 940. In 950, loss L is computed using the soft label \hat{f}_{x′,d,c} and estimated probability distribution \hat{q}_{x,c} respectively determined in 930 and 940. Specifically,

Loss L can be calculated as L=Σ_{c}\hat{π}_{c}S(\hat{q}_{x,c}, \hat{f}_{x′,d,c}), which is the summation, for all c, the scoring rule S(\hat{q}_{x,c}, \hat{f}_{x′,d,c}) with weight parameter \hat{π}_{c}, which can based upon a probability distribution of the censoring time. In certain aspects, the scoring rule S is a Bregman divergence.

In 960, the estimated probability distribution \hat{q}_{x,c} is updated using the Loss L determined in 950. This includes updating the parameters (e.g., of the neural network model) with the Loss L. Next, the predicted \hat{q}ₓ is obtained, as illustrated in FIG. 1B. Then, the estimated probability distribution \hat{q}_{x,c} is determined using the predicted \hat{q}ₓ Operations 930-960 are repeated until the Loss L has been minimized. In 970, once a determination has been made that the Loss L has been minimized, then the estimated probability distribution \hat{q}ₓ can be deemed, in 980, to have converged with (i.e., be equal to) the true probability distribution qₓ and outputted. The present approach assumes that \hat{π}_{c}=π_{c} holds for any c. In other words, assuming that that the estimation \hat{π}_{c} is correct, minimizing \hat{q}_{x,c} leads to the true probability distribution q_{x,c} of event times.

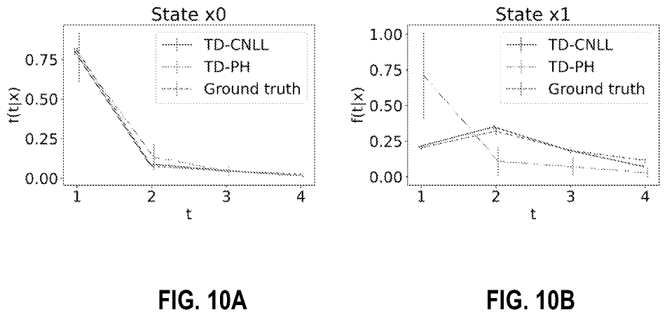

A comparison of four different models (i.e., Initial-S, Landmarking, TD-CNLL, and TD-PH) are illustrated in FIGS. 10AB, 11A-C, and 12A-C. These comparison results are derived from applying the different models to three different datasets: aids, pbc2, and prothro. Table 1 shows a summary of these datasets where the second and third columns show the number of patients and number of observations. The fourth column shows the length of the features.

TABLE I

| Name | # Patients | # Observations | # Features | Censored (%) |
|---|---|---|---|---|
| aids | 467 | 1405 | 9 | 59.7% |
| pbc2 | 312 | 1945 | 20 | 44.9% |
| prothro | 488 | 2968 | 2 | 40.2% |

The continuous times in the datasets was transformed to discrete times by using 32 equal-length intervals, which means that |T|=32. Missing values were also replaced with the media of the values. Except for the TD-PH model, a multi-layer perceptron (MLP) was used to estimate \hat{q}ₓ.

Using a synthetic dataset generated using a simple Markov process, a comparison of the prediction results of TD-CNLL and TD-PH against the ground truth is illustrated in FIGS. 10A-B, respectively, for state x0 and state x1. As shown, the outputs of the TD-PH model were not close to the ground truth due to invalid proportional hazard assumptions. By comparison, the outputs of the TD-CNLL model of the present disclosure were close to the ground truth.

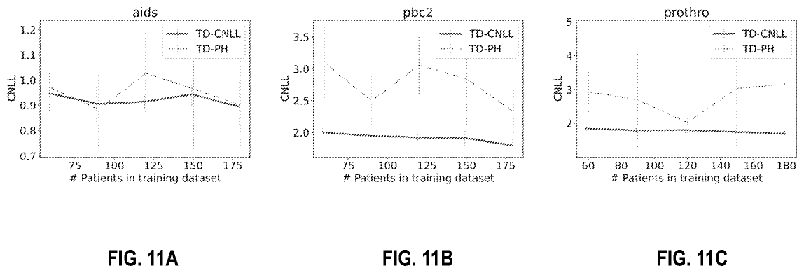

FIGS. 11A-C illustrate, respectively, a comparison of prediction performance between TD-CNLL and TD-PH on the three datasets described above. Since the TD-PH model works only for datasets with unit intervals, all time information was replaced with the number of steps from the initial observation to make the unit interval datasets. As illustrated, while the TD-CNLL and TD-PH showed comparable performance for the aids dataset, TD-CNLL outperformed TD-PH on the pbc2 and prothro datasets.

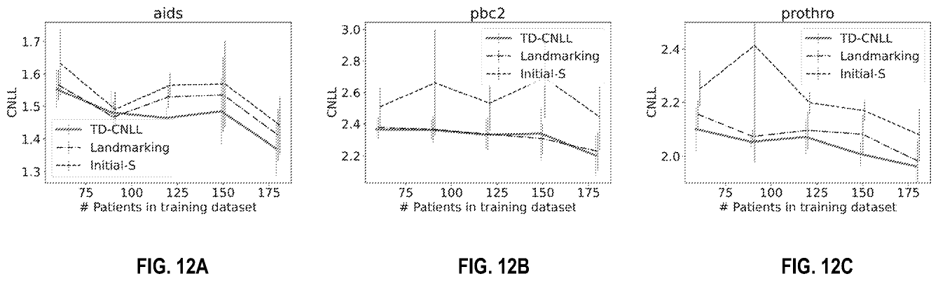

Referring to FIGS. 12A-C, without using the proportional hazard assumption and the unit interval assumption, the prediction performance of the Initial-S, Landmarking, and TD-CNLL models were compared for all three models using the censored negative log-likelihood as an evaluation metric. As illustrated, the TD-CNLL performed best among these three models. While the Landmarking and TD-CNLL models showed comparable performance on the pbc2 dataset, the TD-CNLL model of the present disclosure was the best for the aids and prothro datasets.

The TD-CNLL model of the present disclosure that employs soft labels demonstrates better sample efficiency that the Initial-S and Landmarking models. Additionally, unlike the TD-PH model, the TD-CNLL model does not rely on the proportional hazard assumption and the unit time assumption. Moreover, while the theoretical analysis underlying the TD-PH model assumes that the underlying transition matrix or its approximation is known, the TD-CNLL model does not require such an assumption. Additionally, the TD-CNLL model can be extended for other popular reinforcement learning approaches such as TCSR(λ) (Temporal Change Sensitive Representation) and SARSA (State Action Reward State Action).

For ease of reference, the following nomenclature is used in the present disclosure.

τ is observation time in set of discrete times T.

x is state in set of states X.

(x, τ) is an observation.

(x′, τ′) is a next observation.

( [symbol] , [symbol] ) is a last observation.

Ø_{T} is terminal state.

c is a stopping time or censoring time.

Ø_{C} is state that Markov process stops at time c.

tₓ is event time.

f(t|x) is probability of event occurrence at time t.

S(t|x) is survival function at time t.

h(t|x) is hazard function at time t.

qₓ is a length-K vector that represents the probability distribution of event times for state x.

Δ_{K} is K-simplex of probability vectors defined by Δ_{K}={qₓ∈[0,1]^{K}|∥qₓ∥₁=1}.

L is a loss.

\hat{f}x′, d is a soft label constructed as a probability distribution in a form of length-K vector (i.e., \hat{f}_{x′,d}∈Δ_{K}).

π_{c} is probability that the censoring time is equal to c (i.e., π_{c}=PR(C=c)).

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

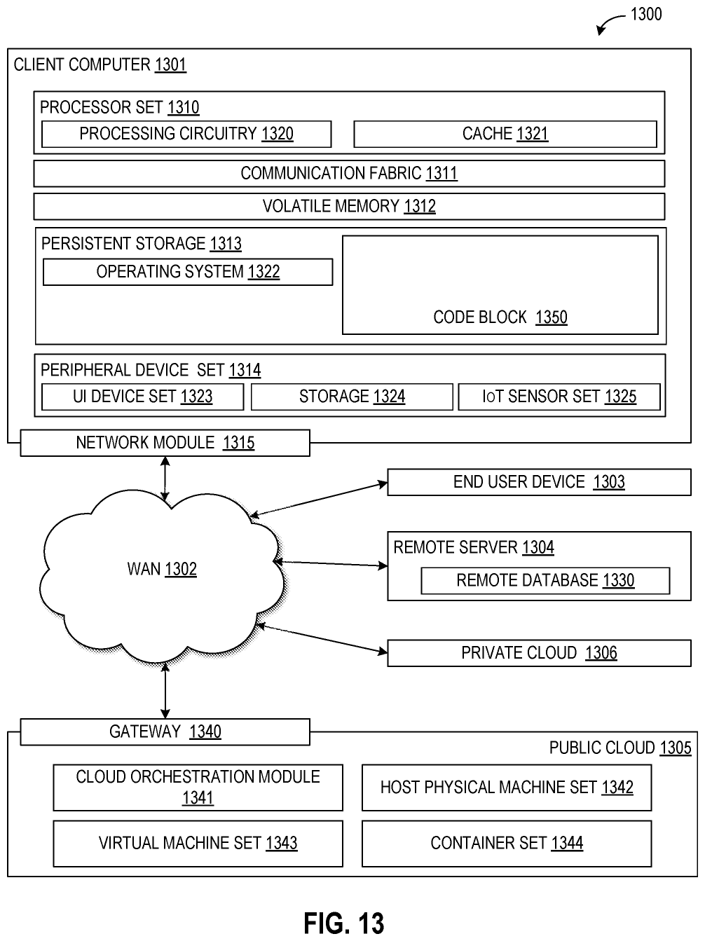

Referring to FIG. 13, computing environment 1300 contains an example of an environment for the execution of at least some of the computer code involved in performing the inventive methods, such as code block 1350 for training a neural network prediction model for survival analysis. Computing environment 1300 includes, for example, computer 1301, wide area network (WAN) 1302, end user device (EUD) 1303, remote server 1304, public cloud 1305, and private cloud 1306. In certain aspects, computer 1301 includes processor set 1310 (including processing circuitry 1320 and cache 1321), communication fabric 1311, volatile memory 1312, persistent storage 1313 (including operating system 1322 and method code block 1350), peripheral device set 1314 (including user interface (UI), device set 1323, storage 1324, and Internet of Things (IoT) sensor set 1325), and network module 1315. Remote server 1304 includes remote database 1330. Public cloud 1305 includes gateway 1340, cloud orchestration module 1341, host physical machine set 1342, virtual machine set 1343, and container set 1344.

Computer 1301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1330. As is well understood in the art of computer technology, and depending upon the technology, performance of a computer-implemented method may be distributed among multiple computers and/or between multiple locations. However, to simplify this presentation of computing environment 1300, detailed discussion is focused on a single computer, specifically computer 1301. Computer 1301 may or may not be located in a cloud, even though it is not shown in a cloud in FIG. 13 except to any extent as may be affirmatively indicated.

Processor set 1310 includes one, or more, computer processors of any type now known or to be developed in the future. As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. Processing circuitry 1320 may be distributed over multiple packages, for example, multiple, coordinated integrated circuit chips. Processing circuitry 1320 may implement multiple processor threads and/or multiple processor cores. Cache 1321 is memory that is located in the processor chip package(s) and is typically used for data or code that should be available for rapid access by the threads or cores running on processor set 1310. Cache memories are typically organized into multiple levels depending upon relative proximity to the processing circuitry. Alternatively, some, or all, of the cache for the processor set may be located “off chip.” In certain computing environments, processor set 1310 may be designed for working with qubits and performing quantum computing.

Computer readable program instructions are typically loaded onto computer 1301 to cause a series of operational steps to be performed by processor set 1310 of computer 1301 and thereby effect a computer-implemented method, such that the instructions thus executed will instantiate the methods specified in flowcharts and/or narrative descriptions of computer-implemented methods discussed above in this document (collectively referred to as “the inventive methods”). These computer readable program instructions are stored in various types of computer readable storage media, such as cache 1321 and the other storage media discussed below. The program instructions, and associated data, are accessed by processor set 1310 to control and direct performance of the inventive methods. In computing environment 1300, at least some of the instructions for performing the inventive methods may be stored in code block 1350 in persistent storage 1313.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Communication fabric 1311 is the signal conduction paths that allow the various components of computer 1301 to communicate with each other. Typically, this communication fabric 1311 is made of switches and electrically conductive paths, such as the switches and electrically conductive paths that make up busses, bridges, physical input/output ports and the like. Other types of signal communication paths may be used for the communication fabric 1311. such as fiber optic communication paths and/or wireless communication paths.

Volatile memory 1312 is any type of volatile memory now known or to be developed in the future. Examples include dynamic type random access memory (RAM) or static type RAM. Typically, the volatile memory 1312 is characterized by random access, but this is not required unless affirmatively indicated. In computer 1301, the volatile memory 1312 is located in a single package and is internal to computer 1301. In addition to alternatively, the volatile memory 1312 may be distributed over multiple packages and/or located externally with respect to computer 1301.

Persistent storage 1313 is any form of non-volatile storage for computers that is now known or to be developed in the future. The non-volatility of the persistent storage 1313 means that the stored data is maintained regardless of whether power is being supplied to computer 1301 and/or directly to persistent storage 1313. Persistent storage 1313 may be a read only memory (ROM), but typically at least a portion of the persistent storage 1313 allows writing of data, deletion of data and re-writing of data. Some familiar forms of persistent storage 1313 include magnetic disks and solid state storage devices. Operating system 1322 may take several forms, such as various known proprietary operating systems or open source Portable Operating System Interface type operating systems that employ a kernel. The code included in code block 1350 typically includes at least some of the computer code involved in performing the inventive methods.

Peripheral device set 1314 includes the set of peripheral devices for computer 1301. Data communication connections between the peripheral devices and the other components of computer 1301 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet.

In various aspects, UI device set 1323 may include components such as a display screen, speaker, microphone, wearable devices (such as goggles and smart watches), keyboard. mouse, printer, touchpad, game controllers, and haptic devices. Storage 1324 is external storage, such as an external hard drive, or insertable storage, such as an SD card. Storage 1324 may be persistent and/or volatile. In some aspects, storage 1324 may take the form of a quantum computing storage device for storing data in the form of qubits. In aspects where computer 1301 is required to have a large amount of storage (for example, where computer 1301 locally stores and manages a large database) then this storage 1324 may be provided by peripheral storage devices designed for storing very large amounts of data, such as a storage area network (SAN) that is shared by multiple, geographically distributed computers. Internet-of-Things (IoT) sensor set 1325 is made up of sensors that can be used in IoT applications. For example, one sensor may be a thermometer and another sensor may be a motion detector.

Network module 1315 is the collection of computer software, hardware, and firmware that allows computer 1301 to communicate with other computers through a Wide Area Network (WAN) 1302. Network module 1315 may include hardware, such as modems or Wi-Fi signal transceivers, software for packetizing and/or de-packetizing data for communication network transmission, and/or web browser software for communicating data over the internet. In certain aspects, network control functions and network forwarding functions of network module 1315 are performed on the same physical hardware device. In other aspects (for example, aspects that utilize software-defined networking (SDN)), the control functions and the forwarding functions of network module 1315 are performed on physically separate devices, such that the control functions manage several different network hardware devices. Computer readable program instructions for performing the inventive methods can typically be downloaded to computer 1301 from an external computer or external storage device through a network adapter card or network interface included in network module 1315.

WAN 1302 is any Wide Area Network (for example, the internet) capable of communicating computer data over non-local distances by any technology for communicating computer data, now known or to be developed in the future. In some aspects, the WAN 1302 ay be replaced and/or supplemented by local area networks (LANs) designed to communicate data between devices located in a local area, such as a Wi-Fi network. The WAN 1302 and/or LANs typically include computer hardware such as copper transmission cables, optical transmission fibers, wireless transmission, routers, firewalls, switches, gateway computers and edge servers.

End user device (EUD) 1303 is any computer system that is used and controlled by an end user (for example, a customer of an enterprise that operates computer 1301), and may take any of the forms discussed above in connection with computer 1301. EUD 1303 typically receives helpful and useful data from the operations of computer 1301. For example, in a hypothetical case where computer 1301 is designed to provide a recommendation to an end user, this recommendation would typically be communicated from network module 1315 of computer 1301 through WAN 1302 to EUD 1303. In this way, EUD 1303 can display, or otherwise present, the recommendation to an end user. In certain aspects, EUD 1303 may be a client device, such as thin client, heavy client, mainframe computer, desktop computer and so on.

As defined herein, the term “client device” means a data processing system that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein. As defined herein, the term “user” means a person (i.e., a human being).

Remote server 1304 is any computer system that serves at least some data and/or functionality to computer 1301. Remote server 1304 may be controlled and used by the same entity that operates computer 1301. Remote server 1304 represents the machine(s) that collect and store helpful and useful data for use by other computers, such as computer 1301. For example, in a hypothetical case where computer 1301 is designed and programmed to provide a recommendation based on historical data, then this historical data may be provided to computer 1301 from remote database 1330 of remote server 1304. As defined herein, the term “server” means a data processing system configured to share services with one or more other data processing systems.

Public cloud 1305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1305 is performed by the computer hardware and/or software of cloud orchestration module 1341. The computing resources provided by public cloud 1305 are typically implemented by virtual computing environments that run on various computers making up the computers of host physical machine set 1342, which is the universe of physical computers in and/or available to public cloud 1305. The virtual computing environments (VCEs) typically take the form of virtual machines from virtual machine set 1343 and/or containers from container set 1344. It is understood that these VCEs may be stored as images and may be transferred among and between the various physical machine hosts, either as images or after instantiation of the VCE. Cloud orchestration module 1341 manages the transfer and storage of images, deploys new instantiations of VCEs and manages active instantiations of VCE deployments. Gateway 1340 is the collection of computer software, hardware, and firmware that allows public cloud 1305 to communicate through WAN 1302.

VCEs can be stored as “images,” and a new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 1306 is similar to public cloud 1305, except that the computing resources are only available for use by a single enterprise. While private cloud 1306 is depicted as being in communication with WAN 1302, in other aspects, a private cloud 1306 may be disconnected from the internet entirely (e.g., WAN 1302) and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this aspect, public cloud 1305 and private cloud 1306 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

As another example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. Each block in the flowchart or block diagrams may represent a module, segment, or portion of instructions, which comprises one or more executable instructions for implementing the specified logical function(s).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” “one arrangement,” “an arrangement,” “one aspect,” “an aspect,” or similar language means that a particular feature, structure, or characteristic described in connection with the embodiment is included in at least one embodiment described within this disclosure. Thus, appearances of the phrases “one embodiment,” “an embodiment,” “one arrangement,” “an arrangement,” “one aspect,” “an aspect,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting.” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “if,” “when,” “upon,” “in response to,” and the like are not to be construed as indicating a particular operation is optional. Rather, use of these terms indicate that a particular operation is conditional. For example and by way of a hypothetical, the language of “performing operation A upon B” does not indicate that operation A is optional. Rather, this language indicates that operation A is conditioned upon B occurring.

The foregoing description is just an example of embodiments of the invention, and variations and substitutions. While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

What is claimed is:

1. A computer-implemented method for training a prediction model for dynamic survival analysis of a training survival dataset representing a plurality of individuals, comprising:
initializing, for a batch of data from the training survival dataset, an estimated probability distribution for the prediction model;
determining, for each of a plurality of censored individuals, an individual estimated probability distribution;
constructing a soft label, for each of the plurality of censored individuals, by shifting the estimated individual probability distribution for a respective one of the plurality of censored individuals by a predetermined value;
generating a loss by summing, for each of the plurality of censored individuals, a weighted scoring rule using the soft labels and the individual probability distributions;
modifying the estimated probability function based upon the loss; and
repeating the determining, the generating, the constructing, and the modifying until the loss is minimized, wherein
the survival dataset includes censored data.

2. The method of claim 1, wherein
the soft labels are constructed using an estimation of a probability of event occurrence and an estimation of a probability of survival function.

3. The method of claim 2, wherein
the soft labels are constructed as a probability distribution in a form of a length-K vector.

4. The method of claim 1, wherein
the scoring rule is a Bregman divergence.

5. The method of claim 1, wherein
the scoring rule is weighted by an estimated probability distribution of censoring time.

6. The method of claim 1, wherein
the loss is determined to be minimized using a neural network.

7. The method of claim 6, wherein
the prediction model is a neural network model of the neural network, and
the neural network model determines the individual estimated probability distributions.

8. A computer hardware system for training a prediction model for dynamic survival analysis of a training survival dataset representing a plurality of individuals, comprising:
a hardware processor configured to perform the following executable operations:
initializing, for a batch of data from the training survival dataset, an estimated probability distribution for the prediction model;
determining, for each of a plurality of censored individuals, an individual estimated probability distribution;
constructing a soft label, for each of the plurality of censored individuals, by shifting the estimated individual probability distribution for a respective one of the plurality of censored individuals by a predetermined value;
generating a loss by summing, for each of the plurality of censored individuals, a weighted scoring rule using the soft labels and the individual probability distributions;
modifying the estimated probability function based upon the loss; and
repeating the determining, the generating, the constructing, and the modifying until the loss is minimized, wherein
the survival dataset includes censored data.

9. The system of claim 8, wherein
the soft labels are constructed using an estimation of a probability of event occurrence and an estimation of a probability of survival function.

10. The system of claim 9, wherein
the soft labels are constructed as a probability distribution in a form of a length-K vector.

11. The system of claim 8, wherein
the scoring rule is a Bregman divergence.

12. The system of claim 8, wherein
the scoring rule is weighted by an estimated probability distribution of censoring time.

13. The system of claim 8, wherein
the loss is determined to be minimized using a neural network.

14. The system of claim 13, wherein
the prediction model is a neural network model of the neural network, and
the neural network model determines the individual estimated probability distributions.

15. A computer program product, comprising:
a computer readable storage medium having stored therein program code for training a prediction model for dynamic survival analysis of a training survival dataset representing a plurality of individuals,
the program code, which when executed by a computer hardware system, cause the computer hardware system to perform:
initializing, for a batch of data from the training survival dataset, an estimated probability distribution for the prediction model;
determining, for each of a plurality of censored individuals, an individual estimated probability distribution;
constructing a soft label, for each of the plurality of censored individuals, by shifting the estimated individual probability distribution for a respective one of the plurality of censored individuals by a predetermined value;
generating a loss by summing, for each of the plurality of censored individuals, a weighted scoring rule using the soft labels and the individual probability distributions;
modifying the estimated probability function based upon the loss; and
repeating the determining, the generating, the constructing, and the modifying until the loss is minimized, wherein
the survival dataset includes censored data.

16. The computer program product of claim 15, wherein
the soft labels are constructed using an estimation of a probability of event occurrence and an estimation of a probability of survival function.

17. The computer program product of claim 16, wherein
the soft labels are constructed as a probability distribution in a form of a length-K vector.

18. The computer program product of claim 15, wherein
the scoring rule is a Bregman divergence.

19. The computer program product of claim 15, wherein
the scoring rule is weighted by an estimated probability distribution of censoring time.

20. The computer program product of claim 15, wherein
the loss is determined to be minimized using a neural network,
the prediction model is a neural network model of the neural network, and
the neural network model determines the individual estimated probability distributions.
